(19) United States
(12) Patent Application Publication
(10) Pub. No.: US 2023/0281937 A1
(43) Pub. Date: Sep. 7, 2023

(54) EXTENDED REALITY SYSTEM FOR DISPLAYING ART

(71) Applicant: The Art Standard, Inc., San Francisco, CA (US)

(72) Inventor: Carol Liu, San Francisco, CA (US)

(21) Appl. No.: 18/169,743

(22) Filed: Feb. 15, 2023

Related U.S. Application Data
(60) Provisional application No. 63/317,113, filed on Mar. 7, 2022.

(51) Int. Cl. G06T 19/00

(52) U.S. Cl. CPC G06T 19/006; G06T 2200/08

(57) ABSTRACT

Representations of physical artworks are displayed in an extended reality environment. A physical artwork is scanned to generate an image file, which is viewable in extended reality, such as in a private virtual art gallery on a user device. The user device references a cryptographic ledger to load the images and render the artwork in an extended reality environment. The extended reality environment is augmented with additional content, such as music, text feeds including news or historical context, or other relevant information associated with the artwork. Augmented content is determined based on contextual metadata of a cryptographic token associated with the artwork. Some cryptographic tokens are associated with a fraction of a piece of art. Furthermore, the cryptographic token is encoded with usage parameters, such as privileges or restrictions on when and where an artwork is displayed.

### TECHNICAL FIELD

This application claims the benefit of U.S. Provisional Application No. 63/317,113, filed Mar. 7, 2022, incorporated herein by reference. This document generally relates to displaying art in augmented, virtual, or extended reality (collectively, “XR”).

### BACKGROUND

Many of history’s most famous works of art are on display in major museums around the world, such as the Louvre Museum in Paris, the Tate in London, and the Metropolitan Museum of Art in New York City. However, even large museums such as these currently house the vast majority of their art in storage rather than displaying them in galleries. Museums are forced to archive the bulk of their collections due to various constraints, such as limited display space or the relatively poor condition of some art. Although some archived art is available for viewing on museum websites, viewing art through a web browser is not a satisfactory replacement for visiting the museum. Thus, there is a need to display art such as these archived works in a more engaging manner, thereby enhancing a person’s experience.

### SUMMARY

Methods and systems are disclosed for displaying artwork in an extended reality environment according to attributes of non-fungible tokens (NFTs) associated with the artwork, for example, using the ERC-721 framework. XR devices are increasing in popularity. However, currently NFTs are primarily used to denote ownership and do not include a mechanism that enables the work of art to be easily displayed in XR. To overcome these limitations, the disclosed methods and systems mint an NFT associated with an artwork on a blockchain and display the artwork in an XR environment based on attributes included in metadata of the NFT by an application executing at an XR device of the user.

For example, the attributes included in metadata of the NFT can include contextual information, a time period, or information about the artist, and the application can augment the XR environment with content, such as period appropriate music. In another example, minting the NFT includes an onboarding process where a physical artwork, such as an archived painting in a museum, is scanned, and a digital rendering of the physical artwork is generated. The NFT is minted by executing a smart contract including code that defines usage parameters of the NFT. These usage parameters can include privileges that enable the artwork to be viewed in specified environments or enable interactions between other users who own NFTs.

One example interaction includes allowing viewing access in XR to other users, such as inviting the other users to view the user’s personal VR gallery. Viewing access can also be loaned to other users, similar to how a museum loans artwork for showings in other museums. In some embodiments, a user owns an NFT that represents a fractional share of a work of art. Fractional NFTs can be programmed with lesser privileges compared to NFTs associated with full ownership. For example, owners of a fractional NFT can be given timeshare viewing access, where each owner of a fractional NFT of the same work of art is allotted a time slot to view the work.

The usage parameters can also include restrictions that limit how an NFT can be displayed or used, such as restrictions on sharing or selling the NFT. Embodiments of the present disclosure may implement these features to simultaneously provide proof of ownership and generate extended reality environments using parameters drawn from the blockchain, and overall provide an improved extended reality experience for the user.

### BRIEF DESCRIPTION OF THE DRAWINGS

FIG. 1 shows an example system for displaying artwork in extended reality.

FIG. 2 shows an example display of artwork in augmented reality.

FIG. 3 shows another example display of artwork in augmented reality.

FIG. 4 shows an example display of artwork in virtual reality.

FIG. 5 is a block diagram illustrating a data structure of a smart contract.

FIG. 6 is a flowchart illustrating a method of displaying artwork.

FIG. 7 is a flowchart illustrating a method of implementing a group event in extended reality.

FIG. 8 shows an example block diagram representation of a cryptographic token.

FIG. 9 is a block diagram of a computer system as may be used to implement features of some embodiments of the disclosed technology

### DETAILED DESCRIPTION

Extended reality (XR) generally refers to immersive technology that enables users to interact with a virtual environment in addition to, or instead of, the physical environment. For example, XR technology can include virtual reality (VR), augmented reality (AR), or mixed reality (MR) technologies. VR devices display a virtual environment that replaces the user’s physical environment. Example VR devices include Oculus Quest®, Playstation VR®, and HTC Vive®. In contrast, AR devices may add digital graphics to the existing physical environment. Example AR devices include wearable devices such as headsets and smart glasses, but also include mobile phones and tablets equipped with cameras.

One facet of the present application is blockchain-based technology. A blockchain is a continuously growing list of records, called blocks, which are linked and secured using cryptography. Each block may contain a hash pointer as a link to a previous block, a timestamp, and transactional data (e.g., each block may include many transactions). By design, a blockchain is inherently resistant to modification of already-recorded transactional data (i.e., once a block is appended to the blockchain, it cannot be changed). Additional blocks may be appended to a blockchain, where each additional block (i.e., “change”) may be recorded on the blockchain. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes.

Although originally developed for transactions of currency, blockchains can be used to support transactions of other types, such as those relating to the sale of vehicles, sale of financial derivatives, sale of stock, payments on contracts, and so on. For example, a non-fungible token (NFT) can uniquely identify something that can be owned. An NFT for a physical or digital asset can be generated using a cryptographic one-way hash of information that uniquely identifies the asset. The creation of an NFT for an asset in a blockchain establishes provenance of the asset, a process referred to as “minting.” The NFT can be used in transactions (e.g., buying, selling, insuring, securing obligations) involving the asset stored in a blockchain, creating a full audit trail of the transactions.

Smart contracts enable more complex transactions. A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain.

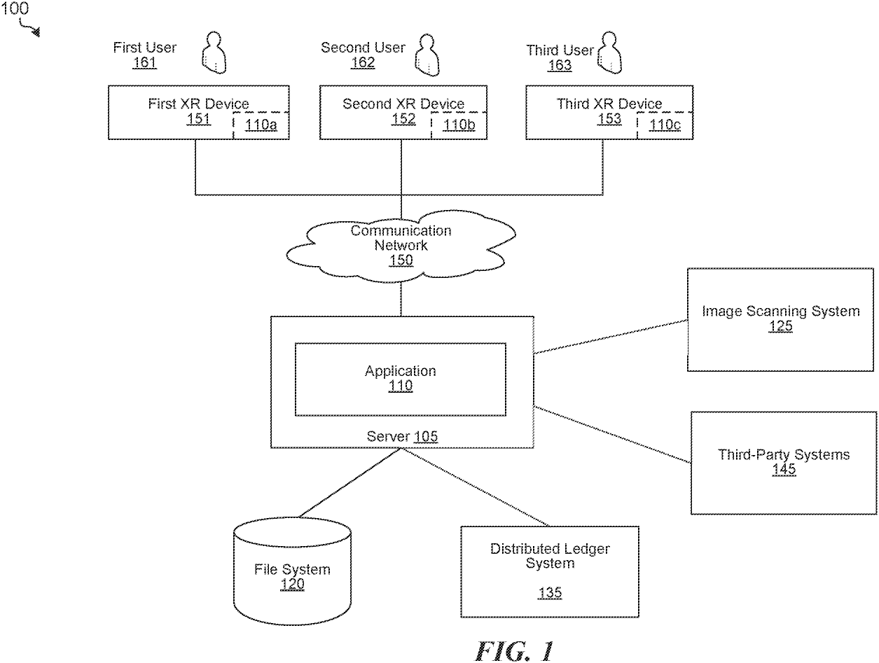

FIG. 1 shows an example system 100 for displaying artwork in extended reality. The system 100 includes an application 110 that facilitates display of artwork in XR. The application 110 is implemented on a server 105 (“server”), and is accessible from a mobile application on an XR device associated with a user, such as mobile apps 110a-110c. The mobile apps 110a-c are downloaded onto an XR device, e.g., from an app store (not illustrated). The XR device, such as XR devices 151-153 associated with users 161-163, respectively, can be any of a variety of computing devices, e.g., a laptop computer, a smartphone, a tablet PC, or a wearable AR or VR headset. The XR devices 151-153 are capable of communicating with the server 105 over a communication network 150, e.g., Internet, Intranet, or Local Area Network (LAN).

The users 161-163 purchase NFTs associated with works of art, which are then stored in the users’ cryptographic wallets. In some embodiments, each user’s cryptographic wallet is hosted on the XR devices 151-153 and accessed through the mobile applications 110a-c. Alternatively, a user’s cryptographic wallet is hosted on the server 105. Ownership of the NFTs is recorded in a distributed ledger system 135, such as a blockchain. The NFTs are minted by executing smart contracts, which govern how each user 161-163 can use the corresponding NFT by defining access permissions. The smart contract code and NFT metadata are also recorded as part of a distributed, decentralized blockchain network in the distributed ledger system 135.

The public ledger system of a blockchain provides secure ownership of the NFTs and is used to authenticate ownership of NFTs when the XR devices 151-153 display the associated works of art. The blockchain is further used to verify transactions between the users 161-163, for example trades or sales of NFTs.

The image scanning system 125 generates digital image files from physical works of art, such as paintings, sculptures, or other works. The image scanning system 125 includes cameras, flatbed scanners, laser scanners such as LiDAR, or other imaging devices. The image scanning system 125 further includes one or more image processing modules. For example, the image processing modules generates three-dimensional images from multiple two-dimensional images, corrects color and brightness, and performs other image processing tasks.

In some embodiments, the image files produced by the image scanning system 125 are stored in the file system 120. For example, when an XR device 151-153 attempts to load the images needed to display works of art, the XR device 151-153 accesses a link to the file system 120 in the metadata of the associated NFT. The file system 120 can be either centralized or distributed. One example distributed file system 120 implements an InterPlanetary File System (IPFS), which is a protocol and peer-to-peer network for storing and sharing data. A distributed file system provides redundancy in the form of multiple nodes in case an image file becomes corrupted or otherwise inaccessible at one node. In some embodiments, the image files stored in the file system 120 are encrypted to prevent non-owners of an NFT from accessing the image files. In some embodiments, image files are stored in the distributed ledger system 135, though in general it is more efficient to retrieve larger images suitable for VR from a separate file system, such as the file system 120. Therefore, in some implementations, smaller image files are stored in the distributed ledger system 135 while larger files are stored in the file system 120.

The application 110 also includes a predictive analytics module, which uses machine learning and artificial intelligence techniques to provide augmented content for display in XR and to generate keyword tags for NFTs. The augmented content includes content stored in the server 105 and content retrieved from the third-party systems 145 over a network. The third-party systems 145 include third-party social networks like Facebook®, Instagram®, or Twitter®, news sources, encyclopedias, and various other sources of augmented content.

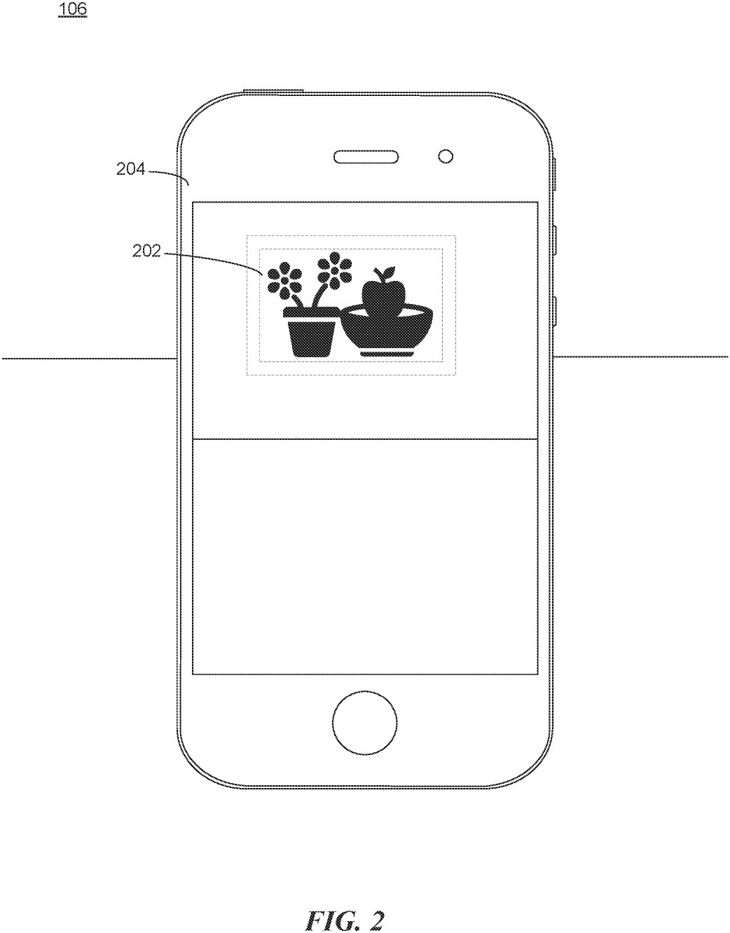

FIG. 2 shows an example display of artwork 202 in augmented reality. The user device 204 executes an application that receives an image of the environment. For example, the user device 204 can be a mobile phone or tablet that includes a camera on the back of the user device 204. As shown in FIG. 2, the artwork 202 is a painting or photograph, that when viewed on the screen of the user device 204, is superimposed on the wall 206.

In some embodiments the displayed artwork 202 is a three-dimensional rendering, so that moving the user device 204 results in displaying different angles of the artwork 202. For example, the artwork 202 corresponds to a physical painting with textures and layers of paint, which are captured in the digitizing process. An example process to digitize a work of art in 3D includes capturing a plurality of source images of the work at different angles. For example, a digital camera periodically captures images or record video while attached to a mechanical arm or moving along a fixed rail. By capturing multiple images of the same area of a painting at known distances, the topography of the painting can be derived. In some embodiments, texture is ascertained by illuminating a painting at different angles, which produces shadows or highlights of different lengths. The plurality of images is then processed and stitched together by software to produce a 3D image for display in XR.

The images then undergo further post-processing, such as adjusting color, contrast, reducing noise, etc. Because viewing conditions may vary, such as between AR and VR or between different device displays, the post-processing step produces images optimized for these varying conditions. Post-processing is also necessary when the source artwork is in poor condition. Post-processing enables a painting to be digitally “restored” in XR, similar to how a decayed painting is restored through cleaning, stretching, and repainting steps. Image processing and correction is performed using various software tools, such as Photoshop®. In some embodiments, artificial intelligence aids in image processing, for example by analyzing the color palette of similar artworks and correcting faded colors accordingly.

In addition, the AR display is configured to display other types of art, such as sculptures or more elaborate installations including multiple pieces and types of art. Digitizing sculptures is generally performed in a similar manner to paintings, though at a greater range of angles. In some embodiments, other imaging methods such as Light Detection and Ranging (LiDAR) scanning is used to produce 3D models for display in XR.

In some embodiments, multiple digital images are produced of the same work of art for display in XR. For example, a lower resolution image can be displayed when a user’s avatar is relatively far from the work in VR, while a higher resolution image is displayed when the user observes the work closely. The display can smoothly transition between one or more intermediate images with varying resolution and detail as the user’s avatar approaches the work in VR. Displaying lower resolution images when the user’s avatar is farther away decreases initial loading times, which can enhance user experience. Viewing can be monoscopic for AR and some VR experiences, or stereoscopic VR to give the user a sense of depth.

The user device 204 displays augmented content that enhances user experience, such as digital furniture or contextual information relating to the artwork 202. Further discussion on augmenting content in XR is provided below.

The artwork 202 is tied to a cryptographic token, such as a non-fungible token (NFT). The NFT is minted on a blockchain, such as Ethereum, Bitcoin, Cardano, etc. In some implementations, the artwork 202 is a digital rendering of a physical artwork, such as an archival museum painting or sculpture. In some embodiments, the artwork 202 is not traditional “fine art” such as a painting, sculpture, or photograph and is instead a historical artifact, fossil, commercial art, etc. The digital rendering of the artwork 202 is created as part of an onboarding process, where the artwork 202 is scanned and linked to an NFT that is added to the blockchain.

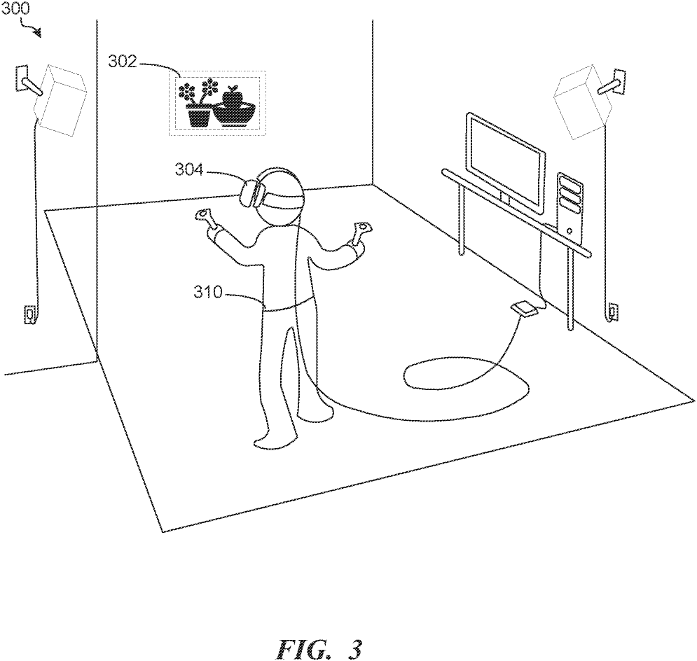

FIG. 3 shows another example display of artwork 302 in augmented reality. The user 310 is shown operating a user device 304 that includes a headset. Examples of the user device 304 include smart glasses, heads up displays, or holographic displays, such as Microsoft Hololens®. The user 310 is in a room 300 in physical space and views the artwork 302 displayed on the wall of the room 300 through the headset of the user device 304. The displayed artwork 302 is generally similar to artwork 202 of FIG. 2, but compared to the user device 204 of FIG. 2, the user device 304 provides a more immersive experience for the user 310. The headset of the user device 304 also includes a headphone component. In some embodiments, the user 310 uses separate headphones that are connected to the user device 104 or 304 through a wired connection or a wireless connection, e.g., Bluetooth®.

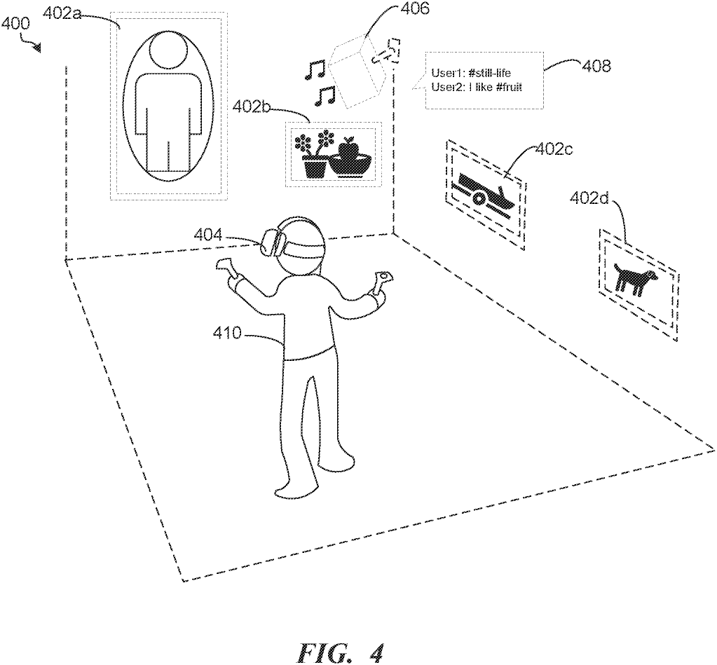

FIG. 4 shows an example display of artworks 402a-d in virtual reality. The user 410 wears a user device 404 that displays a virtual reality environment 400. Although the user 410 is in a physical room, such as room 300 of FIG. 3, the user 410 is immersed in the virtual reality environment 400. In some embodiments, the user device 404 includes a headset that is optically opaque to the physical environment. As shown in FIG. 4, multiple pieces of artwork 402a-d are displayed in the virtual environment 400. Each of the artworks 402a-d are similar to artworks 202 and 302 of FIGS. 2 and 3, but displayed in VR instead of AR. Each of the artworks 402a-d are tied to a corresponding NFT. In some embodiments, the user 410 can visit other user’s virtual environments in order to view other works of art. Similarly, the user 410 can invite other users to enter the virtual environment 400 and view artworks 402a-d. In some embodiments, the users that can be invited are subject to restrictions coded into the smart contract of the NFTs.

The virtual environment 400 is a virtual gallery, but other implementations are not limited to an art gallery. In some examples, the virtual environment 400 is an outdoor environment that replicates an outdoor art installation. In some embodiments, the virtual environment 400 replicates well-known cultural locations such as famous museums or UNESCO® World Heritage Sites. The ability for the user 410 to access certain virtual environments 400 depends on access permissions tied to the NFTs in the user 410′s cryptographic wallet. For example, an artwork is associated with an NFT executed by a specific smart contract, and the code of the smart contract grants the user the privilege to view that artwork in a specific virtual environment 400. In one illustrative example, a function embedded in the smart contract enables an indigenous Native American petroglyph to be viewed in VR at the site where it was originally discovered.

In some embodiments, the virtual environment 400 includes a number of predetermined anchor points or slots where image data corresponding to the artworks 402a-d are inserted. An “anchor point” is used to denote a specific coordinate point where an image is displayed, such as a coordinate where the image’s central point is positioned. A “slot” generally denotes a plurality of coordinates that define an area or shape, such as a square, rectangle, circle, cylinder, etc., where the image resides The position and number of anchor points or slots varies depending on the chosen environment. For example, a “small” gallery that comprises a single room may only include 5 or fewer anchor points or slots, while a “large” environment with multiple rooms and hallways has more anchor points or slots, e.g., 10, 20, 30, etc. In some implementations, the user specifies which artworks to display, and a custom environment with a corresponding number of anchor points is generated. Using predetermined anchor points or slots ensures works of art are properly spaced and prevents the virtual environment 400 is not overly cluttered.

In some implementations, the anchor points or slots are associated with a size or type of artwork. Then when the artworks 402a-d are rendered in the virtual environment 400, they are positioned by size or shape at the proper the anchor point or slot. In some cases, images are rescaled or anchor points are shifted to prevent images from overlapping. Some larger images span multiple slots or anchor points, for example to properly display a large mural that spans an entire wall. In some implementations, the user 410 “previews” the placement of the artworks 402a-d and make changes before the virtual environment 400 is rendered, for example by a drag and drop window. In some implementations, the artworks 402a-d are movable by the user 410. For example, artwork 402c is positioned at a specific anchor point in the virtual environment 400. The user 410 may grab artwork 402c in VR and move the artwork 402c to a different anchor point.

In some embodiments, an NFT is tied to a fraction of a work. For example, artwork 402a is associated with a plurality of NFTs, such as 2, 10, 100, etc., where each NFT is linked to the same physical work of art. Each owner of an associated NFT is then considered a fractional owner. In some embodiments, the ability to display the artwork 402a in AR or VR, as shown in FIGS. 2-4, depends on the ownership interest of each owner. For example, for some NFTs, each fractional owner is allotted a limited amount of time to display the associated work of art in XR. In some embodiments, the amount of time is allotted proportionally with ownership share, i.e., in a timeshare arrangement. In addition, some time slots may be more desired, so owners of larger shares of an NFT can select time slots before owners with smaller ownership shares. Other NFTs are subjected to an event sharing arrangement, where some fractional owners are only able to view the associated work during group events with other fractional owners of the NFT. Other types of usage restrictions associated fractional ownership include a reduced ability to loan artwork, limited display size or resolution, and restrictions on the number or type of devices that can be used (e.g., AR only viewing.) In some implementations, fractional owners of an NFT each have full viewing privileges, while those owners with larger shares have greater access privileges, such as access to events.

The VR environment 400 is augmented by additional content 406 and 408. The augmented content 406 and 408 includes audio and visual content. For example, FIG. 4 shows a speaker 406 in VR that plays audio content. The speaker 406 is shown as one illustrative example, and generally the user 410 hears audio through the user device 404 regardless of whether a virtual speaker 406 is present in the environment 400. In addition, augmented content is not limited to VR, and similar augmented content can be produced for AR environments like shown in FIGS. 1 and 2. The augmented content 406 and 408 is displayed or streamed based on metadata of an NFT associated with the artworks 402a-d. In some examples, the metadata of an NFT includes a link to an audio file, which is hosted on-chain or off-chain, such as on a user device or an external file system. The user device 404 references the metadata to access the audio file, which is then used when generating the VR environment 400.

In some implementations, augmented content 406 and 408 are retrieved over a network from third party sources, such as third-party systems 145 of FIG. 1. For example, text from news articles, third-party social media platforms, or other online sources are retrieved and displayed in the VR environment 400 as a text box or scrolling feed 408. The feed 408 is customized according to the user 410, the artwork 402a-d, or for other properties of the virtual environment 400. For example, the feed 408 is associated with the particular artwork 402b and displays content relating to the artwork 402b. In some embodiments, the feed 408 is associated with the environment 400 and includes content relating to multiple works of art in the environment 400 or a background setting of the environment 400, such as a social media discussion pertaining to all of the artwork 402a-d in the environment 400. In some embodiments, there are multiple feeds 408 that correspond to separate works or separate rooms or galleries within the environment 400.

In some embodiments, an artwork 402a-d is tagged with a keyword. The keyword is user-created, explicitly tagged in the minting process (e.g., in metadata), or implicitly derived, such as by machine learning. For example, the artwork 402b depicting a still life is tagged “#still-life.” The application executing at the user device 404 then retrieves and displays social media posts in the feed 408 that are also tagged “#still-life.” The social media posts include posts from third-party sources, such as Twitter®, as well as posts from a chat feed integrated with the application. In some embodiments, the application retrieves and suggests content that is not explicitly tagged but is otherwise associated with tags attributed to the artwork. For example, associations are derived between tags, so that posts with other tags than #still-life are posted to the feed 408. As shown in FIG. 4 the #still-life tag is associated with #fruit, and posts with both tags are displayed in the feed 408.

In some embodiments, the feed 408 displays content using other metadata in addition to keywords or hashtags. For instance, social media posts are geo-tagged to indicate the location where the posts were created. In one example use of geo-tagged posts, the VR environment 400 comprises a replica of a famous museum, and the feed 308 includes social media posts by people who visit that museum in physical space, further enhancing the museum-like experience for the user 410. The feed 408 also displays content that is popular or trending, such as news headlines. In some embodiments, the feed 408 is tied to a marketplace or auction system implemented on the application, and the feed 408 displays notifications of upcoming auctions or notable sales.

The feed 408 also includes content posted by users of the application, such as text entered into a chat window. As previously discussed, augmented content 406 and 408 comprises a variety of formats. Text is converted to audio, or vice versa, using suitable text-to-speech or transcription techniques prior to being produced in the virtual environment 400. For example, when the user 410 speaks into a microphone of the user device 404, the speech is transcribed and posted into the feed 408.

In some embodiments, augmented content is discovered and identified using machine learning, rather than being explicitly pointed to by a link in the metadata. For example, a machine-learning algorithm is trained to form associations between a set of training content and a set of training attributes. The machine-learning algorithm then identifies information about the artwork by scanning various sources of content, such as biographical information artist of an artwork, and the information is displayed as a text box in the VR environment 400. In some embodiments, the training attributes are drawn from metadata of NFTs on the blockchain. Using existing NFT metadata as training data reduces the need for obtaining or uploading additional training data, which can be a time and resource-intensive process. For example, the metadata of the NFTs include information relating to the artwork such as the artist, time period, art movement, or subject of the artwork. Training content includes tagged audio files, video, articles, images, etc. Once trained, the machine learning algorithm is able to identify or recommend content to augment the AR or VR environment. The content is drawn from links in NFT metadata, from a repository associated with the application (e.g., server 105 or file system 120 of FIG. 1), or from the internet (e.g., third-party systems 145). In some embodiments, augmented content is stored on-chain.

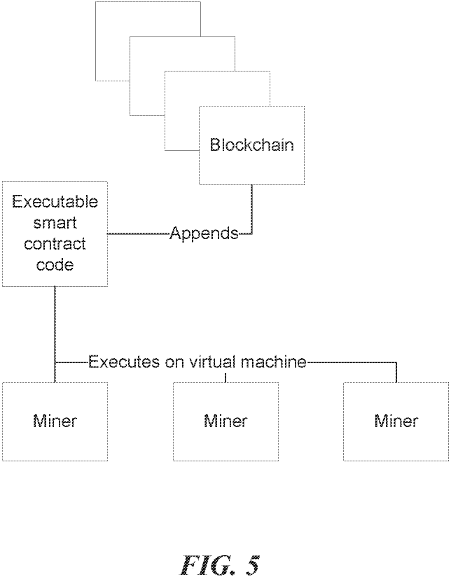

FIG. 5 is a block diagram illustrating a data structure of a smart contract. Smart contracts and decentralized applications (dApps) execute on an Ethereum virtual machine (“EVM”). The EVM is instantiated on available network nodes. Smart contracts and dApps are applications that execute; thus, the processing power to do so must come from hardware somewhere. Nodes must volunteer their processors to execute these operations based on the premise of being paid for the work in Ethereum coins, referred to as Ether, measured in “gas.” Gas is the name for a unit of work in the EVM. The price of gas can vary, often because the price of Ether varies, and is specified within the smart contract/dApp.

Every operation that can be performed by a transaction or contract on the Ethereum platform costs a certain number of gas, with operations that require more computational resources costing more gas than operations that require few computational resources. For example, at the time of writing, a multiplication instruction requires 5 gas, whereas an addition instruction requires 3 gas. Conversely, more complex instructions, such as a Keccak256 cryptographic hash requires 30 initial gas and 6 additional gas for every 256 bits of data hashed.

The purpose of gas is pay for the processing power of the network on execution of smart contracts at a reasonably steady rate. That there is a cost at all ensures that the work/processing being performed is useful and valuable to someone. Thus, the Ethereum strategy differs from a Bitcoin transaction fee, which is only dependent on the size in kilobytes of a transaction. As a result that Ethereum’s gas costs are rooted in computations, even a short segment of code can result in a significant amount of processing performed. The use of gas further enforces incentivizes coders to generate efficient smart contracts/algorithms. Otherwise, the cost of execution may spiral out of control. Unrestricted, an exponential function may bankrupt a given user.

While operations in the EVM have a gas cost, gas has a “gas price” measured in ether. Transactions specify a given gas price in ether for each unit of gas. The fixing of price by transaction enables the market to decide the relationship between the price of ether and the cost of computing operations (as measured in gas). The total fee paid by a transaction is the gas used multiplied by gas price.

If a given transaction offers very little in terms of a gas price, that transaction will have low priority on the network. In some cases, the network miners may place a threshold on the gas price each is willing to execute/process for. If a given transaction is below that threshold for all miners, the process will never execute. Where a transaction does not include enough ether attached (e.g., because the transaction results in so much computational work that the gas costs exceed the attached ether) the used gas is still provided to the miners. When the gas runs out, the miner will stop processing the transaction, revert changes made, and append to the blockchain with a “failed transaction.” Failed transactions may occur because the miners do not directly evaluate smart contracts for efficiency. Miners will merely execute code with an appropriate gas price attached. Whether the code executes to completion or stalls out due to excessive computational complexity is of no matter to the miner.

Where a high gas price is attached to a transaction, the transaction will be given priority. Miners will process transactions in order of economic value. Priority on the Ethereum blockchain works similarly as with the Bitcoin blockchain. Where a user attaches more ether to a given transaction than necessary, the excess amount is refunded back to that user after the transaction is executed/processed. Miners only charge for the work that is performed. A useful analogy regarding gas costs and price is that the gas price is similar to an hourly wage for the miner, whereas the gas cost is like a timesheet of work performed.

A type of smart contract that exists on the Ethereum blockchain are ERC-721 tokens (Ethereum Request for Comment-721). ERC-721 is a technical specification for NFTs. The ERC-721 introduces a standard for NFTs. An ERC-721 token is unique and can have different exclusivity to another token from the same smart contract, maybe due to age, rarity or visuals.

ERC-721 defines a common list of rules for Ethereum tokens to follow within the larger Ethereum ecosystem, allowing developers to accurately predict interaction between tokens. These rules include how the tokens are transferred between addresses and how data within each token is accessed. ERC-721 provides a framework for a means to build a token on top of a base cryptocurrency. In some embodiments herein, enhancements are built on top of the ERC-721 framework, though use of the ERC-721 technical specification is not inherently necessary and is applicable to circumstances where Ethereum is used as the base cryptocurrency.

NFTs have a uint256 variable called tokenId. Thus, for any ERC-721 contract, the pair contract address, uint256 tokenld must be globally unique. That said, a given dApp can have a “converter” that uses the tokenId as input and outputs an image. The image associated with an NFT is generally specified in the smart contract or dApp that mints the NFT.

Disclosure on token protocols has focused on Ethereum. As applicable in this disclosure, Ethereum is a base cryptocurrency. Other base cryptocurrencies exist now and in the future. This disclosure is not limited to application on specifically the Bitcoin or Ethereum blockchains.

In some embodiments, each NFT associated with the same particular artwork is minted by executing smart contracts that share the same functional code, resulting in each owner of the NFTs having the same access permissions. For example, executing smart contracts coded with the same event permissions enables each owner to access group events associated with the particular art work, such as social activities and parties in a VR metaverse. In some embodiments, a group of NFTs, such as those associated with a group of paintings housed by the same museum, are granted similar privileges. For example, all owners of NFTs associated with the same museum can then attend a virtual fundraiser for the museum.

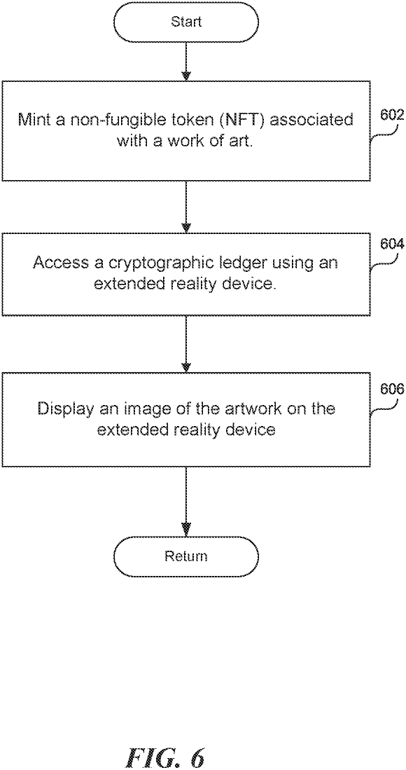

FIG. 6 is a flowchart illustrating a method of displaying artwork. At 602, an NFT associated with an artwork is minted. The NFT minted at 602 is associated with a physical artwork, such an archived work at a museum. Minting the NFT at 602 includes executing a smart contract that cryptographically links the NFT to a given user’s cryptographic wallet address (public key). The underlying artwork represented by image data is linked to the NFT via encoding in the smart contract. Some embodiments of minting of the NFT at 602 include various access restrictions or privileges encoded in the smart contract. In a given example, the NFT minted at 602 is first owned by the museum and subsequently transferred to the cryptographic address of an unaffiliated user. The transfer transaction is recorded on the blockchain. Alternatively, the NFT minted at 602 is directly linked to the cryptographic address of the user via the smart contract. For example, if the user already agreed to purchase the NFT. In either case, the NFT is stored linked to the user’s cryptographic wallet. In some embodiments, the link between the NFT and the cryptographic address is fractional. A fractional link causes certain limitations on access discussed below.

At 604, a user’s XR device makes a request of the cryptographic ledger. The XR devices accesses the cryptographic ledger based on reference to the user’s cryptographic wallet. For example, the user’s cryptographic wallet is inspected via a node to the blockchain, or the wallet can be hosted on the user’s device. The cryptographic ledger is used to record and verify a link between the NFTs and the user’s cryptographic wallet, including the NFT minted at 602.

At 606, an image of the artwork associated with the NFT minted at 602 is displayed on the user’s extended reality device. The image of the artwork can be rendered in the XR device based on image data that is either stored on the cryptographic ledger, image data that is referenced in metadata of the NFT, or by calling a database using the NFT as login credentials (e.g., the user’s private key to their wallet is used to authenticate a session with the database). In some embodiments, the NFT metadata includes a link to an encrypted file system that is decrypted by the private or public key of the user. The image data includes image files suitable for rendering in AR or VR. In some embodiments, multiple works of art are displayed at 606 that correspond with different NFTs in the user’s cryptographic wallet in an immersive environment. For example, the multiple works are displayed in a VR gallery or arrange on the walls of a room the user is in, in AR. The image data can further include environmental data used to render a VR environment, such as graphics depicting a UNESCO® World Heritage Site. If no environmental data is included, then the extended reality device renders a default environment, such as a default gallery, either stored on the extended reality device or retrieved from a central server.

If the NFT is minted with access restrictions at 602, then the image of the artwork is generated accordingly at 606. For example, if the user is only permitted to view the work on Fridays or during between 9AM to 5PM, then the extended reality device can execute a corresponding function in the smart contract that denies the user viewing access if the current date is not Friday or during the hours specified. Other examples include access during specific events, such as a gallery showing. More specifically, examples of access restrictions to users with fractional links include access on a timeshare basis, or on an event share basis.

In some embodiments, NFTs associated with the same artwork are minted into separate tiers, where different tiers are associated with different usage restrictions or privileges. These restrictions and privileges are implemented by the code of each smart contract. Thus, different tiers are implemented by executing different smart contracts for each tier of NFT. For example, with reference to FIG. 4, an owner of an NFT in a first tier is enabled to view artwork 402a at full size, while an owner of an NFT in a second tier is only enabled to view artwork 402a at a smaller size. In another example, owners of first tier NFTs receive special VIP access at events, while lower tier NFT owners receive general access at the same events. Other restrictions or privileges include invitations to events in VR, access to community spaces, the ability to view in different environments, exclusive picture frames, restrictions on sale or transfer, access to additional content, such as educational virtual tours, or the ability to access bonus works of art. In some embodiments, different tiers of NFTs are minted to correspond to different amounts of fractional ownership. For example, users who own a fraction of an artwork above a certain threshold can have their NFTs upgraded to a higher tier. In some embodiments, different tiers of NFTs are minted and sold directly, e.g., as part of a museum fundraiser.

Because the NFT is unique and verifiable as part of the blockchain, a user is able to use their NFT as a ticket or passport to events in the physical world, for example by displaying and scanning a unique QR code generated by the user’s cryptographic wallet. In some implementations, a museum first sells NFTs of works stored in its archive and then holds in-person events or offers discounted admission for owners of those NFTs. For blockchains that also support currency, the QR code allows users to initiate payments, such as for museum entry fees or donations.

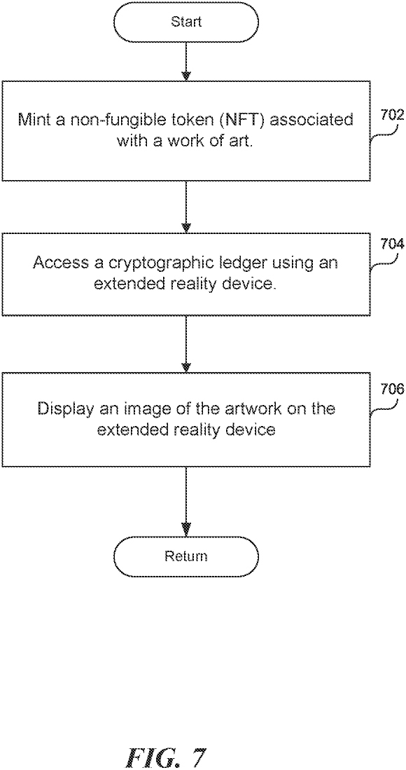

FIG. 7 is a flowchart illustrating a method of implementing a group event in extended reality. At 702, a user who owns an NFT receives an invite to a group event. The invite is initiated by another NFT owner, such as an invitation to view a private gallery. Alternatively, the invite is initiated by another party, such as a museum. For example, the museum is able to invite owners of NFTs associated with works of art that reside at the museum to a VR fundraiser. In some embodiments, the invite includes an encrypted link that is decrypted by a key stored in the user’s cryptographic wallet.

At 704, the user’s access privileges are verified. In some implementations, access is verified by executing code in the smart contracts associated with the user’s NFTs. For example, if the user owns an NFT in a lower tier that precludes access to certain events, executing the smart contract code results in a denial of access. In another example, a group event is intended only for owners of an NFT associated with a particular work of art. To verify whether a user has access to the group event, the device or server hosting the event can reference the cryptographic ledger to verify ownership of the requisite NFT. In some embodiments, invites are only sent to users with the requisite access privileges, so the verification at 704 is performed prior to the user receiving an invite at 702. In yet other embodiments, access is verified by a key stored in the user’s cryptographic wallet. For instance, an event invite is transmitted by an encrypted message that is decrypted by a user’s public key

At 706, the event is displayed on the user’s extended reality device. In some embodiments, the event is held in a common VR space, similar to VR environment 400 of FIG. 4. Alternatively, the event is exclusively held in AR or as a mixed event that where invitees attend the event in either VR or AR. In some embodiments, the event is displayed similarly for all attendees at the group event. For example, each attendee views the same art, hears the same music, and is able to interact with any other user. In other embodiments, the event is displayed differently according to each user’s NFT ownership tier. For example, attendees in a higher ownership tier are able to view a private VR gallery while attendees in a lower tier cannot see the private gallery at all. In another example, attendees of different tiers interact experience different augmented content at the same event.

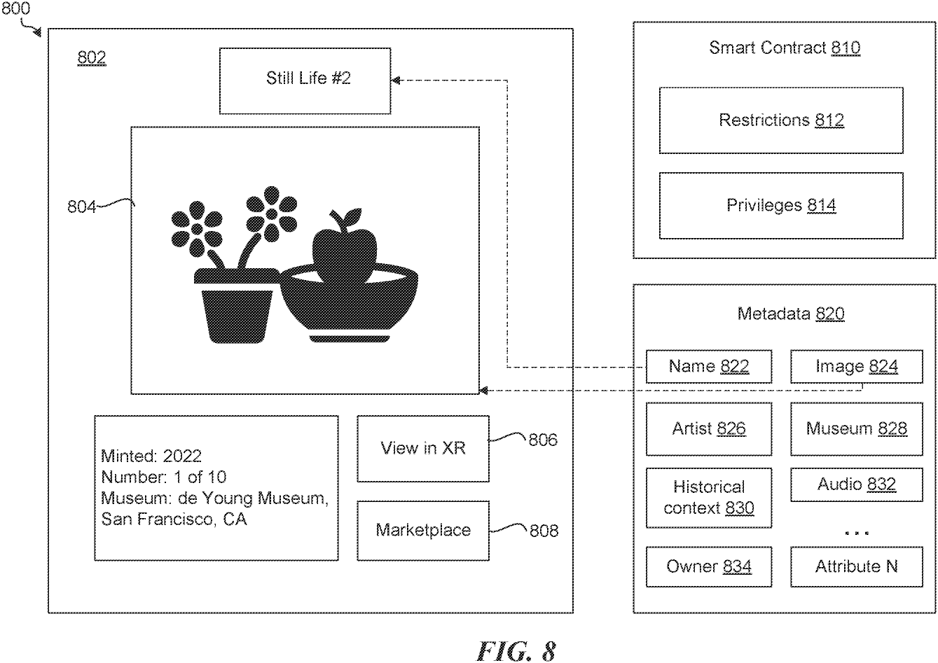

FIG. 8 shows an example block diagram representation of a non-fungible token 800. The NFT 800 is accessed through a cryptographic wallet that comprises a private key of the wallet’s owner. In some embodiments, each user’s private keys are stored online as part of a custodial service and managed by a central platform. The user then accesses the wallet through a browser or application from a user device. Alternatively, the user’s cryptographic wallet is run in a noncustodial manner as a software application on a user device or stored in a separate hardware device. In general, a noncustodial wallet offers a user greater security and control over their private key but may be less convenient, such as in the case of a lost password.

Regardless of how a user’s cryptographic wallet is implemented, information relating to the NFT is viewed in a graphical user interface (GUI) 802 component of an application running on a user device, such as user devices 204, 304, and 404 of FIGS. 2-4. For a custodial wallet, the GUI 802 is used to access contents of the wallet while the private key is managed by a third party. For a software-based cryptographic wallet run on a user device, the GUI 802 operates in a similar fashion, but the private keys are stored on the user device. The GUI 802 is shown for illustrative purposes, and different elements and arrangements of GUI elements can be used. In some examples, a GUI on a mobile phone has a different design than a GUI displayed on a VR headset. Example GUI elements include an image area 804 that displays the artwork associated with the NFT 400. A viewing element 806 can be used to activate AR or VR.

The NFT 800 is associated with a smart contract 810 and includes metadata 820. The smart contract 810 includes code that when executed, mints the NFT to the blockchain. The metadata 820 is used as inputs to the smart contract code. The smart contract 810 defines how the NFT 800 is used, for example by usage restrictions 812 or privileges 814 coded in the smart contract 810. For example, usage restrictions 812 include the ability to prevent sales of the NFT 800. Example privileges 814 coded by the smart contract 810 include the ability to view the artwork in VR or AR in different locations, access events associated with the NFT 800, sell the NFT 800, etc. As discussed earlier, different tiers NFTs are minted according to different usage restrictions 812 or privileges 814 by executing different smart contracts. In some embodiments, different tiers of NFTs associated with one artwork are established by executing smart contracts with the same restrictions 812 and privileges 814 within each tier. The smart contract 810 is stored as a transaction on the blockchain. Encoding usage parameters in the smart contract 810, combined with blockchain consensus and authentication, provides a secure mechanism to ensure that each user cannot exceed the prescribed scope of use of an NFT, nor access features associated with NFTs that are not in the user’s wallet.

The NFT 800 includes metadata 820. The metadata 820 is either stored on-chain or stored off-chain, such as in a peer-to-peer file system. For off-chain metadata 820, the data is pinned, and a hash is appended to the smart contract 810. The metadata 820 includes fields that include attributes of the NFT 800. In some embodiments, the metadata 820 is stored as a JSON file in a file system, such as file system 120 of FIG. 1. FIG. 8 shows a number of fields 822-834 that are included in the metadata 820. For example, the name field 822 is a string of text that names the NFT 800. In some embodiments, a field includes multiple sub-fields, so that multiple attributes are included. For example, the historical context field 830 includes multiple strings of text that describe the subject of an artwork, historical circumstances surrounding the artwork’s creation, etc.

To display a work of art in VR, one or more suitable image files are needed. As described above, a digital rendering of a physical artwork is produced as part of an onboarding process that includes scanning the physical work and performing post processing. In some embodiments, an image file is stored on-chain. Alternatively, image files are stored in a distributed or centralized file system, such as file system 120 of FIG. 1. To access the image files, the application references the image field 824, which includes a string that specifies a hashed URL to the image.

In some embodiments, the image files are encrypted. For example, some images are encrypted by asymmetric-key cryptography, where a public key of the NFT’s owner is used to encrypt the image. The image is then decrypted by a corresponding private key. For example, suitable public-key encryptions techniques include Rivest-Shamir-Adleman (RSA) and Elliptic Curve Digital Signature Algorithm (ECDSA) cryptography. For implementations of asymmetric-key encryption, the image is encrypted by the same public key that the user receives currency with. The user then uses the same paired private key to decrypt the image. In some embodiments, a second public key is used to encrypt the image file, and a corresponding second private key is used to decrypt the image. In some embodiments, the user’s cryptographic wallet includes a plurality of separate private keys that decrypt separate images.

In some implementations, images are encrypted by symmetric-key techniques, such as the Advanced Encryption Standard (AES). For symmetric-key cryptography, images are encrypted by the same private key that the user decrypts the images with. Symmetric-key cryptography involves using a second private key that is shared with the image sender; where the second private key is different from the user’s private key used to sign transactions on the blockchain. In general, asymmetric-key cryptography is more secure but also more computationally intensive than symmetric-key cryptography. Thus, some implementations encrypt different images with different levels of encryption to achieve the optimal balance of performance and security. For example, a fractional first NFT that represents 1% ownership of a first work may be less valuable than a second NFT that represents 100% ownership of a second work, especially if the second work was created by a famous artist. Accordingly, the second NFT links to an encrypted image with a higher level of encryption than an image linked to the fractional first NFT. Besides selecting between symmetric and asymmetric encryption methods, the level of encryption is further varied by using different encryption algorithms, e.g., RSA vs ECDSA, varying the bit-length of the keys, etc.

The viewing element 806 is used to view an artwork in XR. When initialized, the application executing on the user device queries the metadata 820 of the NFT 800. Based on the metadata 820, the application then retrieves the necessary assets to initialize and render the XR environment, such as image files from image field 824, audio files from audio field 832, etc. Querying the smart contract 810 and the metadata 820 upon initialization results in faster response times when inputs are received at the GUI 802, but at the expense of longer loading times upfront. Then when an input to the viewing element 806 is received, the XR environment is displayed on the user device. In some embodiments, an input to viewing element 806 calls functions of the smart contract 810. For example, if the smart contract 810 does not give the user access to VR display of the artwork associated with the NFT 800, then the application returns an access denied response.

In addition to containing an image link, the information in the metadata 420 is used to augment the XR environment with supplemental content. For example, the audio field 832 includes a link to an audio file or playlist that plays when viewing the artwork in XR. In addition, the metadata 820 includes keywords or hashtags. These keywords or hashtags are used to identify similarly tagged content for display or streaming in the XR environment. For example, content tagged with a keyword “#Picasso” includes encyclopedia articles about Picasso, music written by associated composers such as Stravinsky, or videos about Cubism. Augmented content is stored in a content database, such as file system 120 of FIG. 1, or retrieved over a network, such as from third-party systems 145. In addition, associations between keywords are implicitly derived by machine learning to retrieve content with related tags.

In some embodiments, augmented content is discovered and identified using machine learning even if the content is not explicitly tagged with a keyword or hashtag. For example, a machine-learning algorithm is trained to associate common words or phrases with an artist or artwork identified in the metadata 820. The algorithm then searches for content that includes these words or phrases. In some embodiments, such an algorithm is trained using metadata of NFTs on the blockchain. For example, a museum curator provides a description of the various works associated with the NFTs as the NFTs are minted, or users provide their own descriptions after they purchase the NFT. The descriptions, along with the NFT metadata, are then used as inputs to train the algorithm. In some cases, the algorithm is trained using separate pre-labeled sets of art and accompanying description.

In some embodiments, the trained algorithm is used to suggest or populate fields in the metadata 820 during the minting process. For example, the algorithm can be trained to identify Renaissance paintings. Then when a painting is scanned, the algorithm determines a likelihood that the painting is a Renaissance painting and populates the metadata 820 with associated tags, e.g., #michaelangelo, #humanism, #perspective, etc. Automatically populating the metadata 820 using a machine learning model improves the efficiency of the onboarding and minting process by removing the need for a museum curator to identify features and input information.

In some embodiments, the metadata 820 is queried for display on a device in physical space. For example, information from the owner field 834 is retrievable for display on a screen or ticker tape in physical space. In one application, a museum holds a real-life exhibition of various physical artworks associated with a plurality of NFTs and installs a ticker tape that displays all owners of the corresponding NFTs. In this example, the NFTs are first selected by searching in the metadata using the museum field 828 to find works associated with the museum. Then owner information from the owner field 834 is extracted from these selected NFTs. Using metadata fields improves search efficiency and reduces the time needed to search for relevant information. In addition, metadata is publicly verifiable as part of the blockchain. In some embodiments, the metadata 820 does not include an owner field 834, and owner information is derived from the record of transactions on the blockchain.

The marketplace element 808 gives access to a user to buy, sell, or trade NFTs through an online marketplace, e.g., executed at the server 105 of FIG. 1. In some implementations, the NFT 800 is stored on a blockchain that also supports a currency token, enabling users to purchase NFTs directly. For example, the NFT 800 is implemented using Ethereum or a similar custom blockchain. In some embodiments, the marketplace allows users to exchange their existing currencies, such as Bitcoin or fiat currency, for native blockchain currency.

The NFTs are be sold in a variety of formats, such as by auction or fixed-price. In some embodiments, NFTs are sold as “drops,” where an NFT is made available to users in limited quantities at a predetermined time. As discussed above, the NFT 400 is minted based on an existing physical artwork in a museum. In some cases, the seller of the NFT 400 is the museum that houses the artwork. Selling the NFT 800 is thus an additional source of museum fundraising, which traditionally relies on donations from the public, government grants, etc.

In some embodiments, users trade, buy, or sell NFTs with other users of the application. When a user sells or trades away an NFT 800, the user loses privileges associated with the NFT 800 that were specified in the smart contract 810. For example, if a user sells their NFT associated with a particular museum through the marketplace, they are no longer be able to join a VR space for patrons of that museum. Because transactions are recorded on the blockchain, the user is not able to “double spend” the NFT and retain access. In some embodiments, the smart contract 810 specifies that an NFT cannot be transferred or specifies conditions of the transfer. If a user tries to transfer an NFT with a sales or transfer restriction, then the application calls the corresponding functions of the smart contract 810 to ensure that the conditions are met.

### Computer System

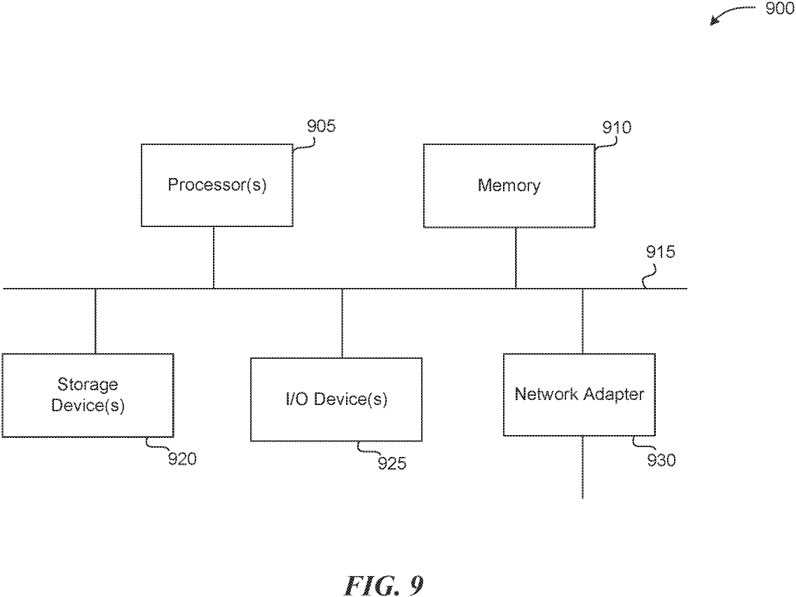

FIG. 9 is a block diagram of a computer system as may be used to implement features of some embodiments of the disclosed technology. The computing system 900 may be used to implement any of the entities, components or services depicted in the foregoing figures (and any other components described in this specification). The computing system 900 may include one or more central processing units (“processors”) 905, memory 910, input/output devices 925 (e.g., keyboard and pointing devices, display devices), storage devices 920 (e.g., disk drives), and network adapters 930 (e.g., network interfaces) that are connected to an interconnect 915. The interconnect 915 is illustrated as an abstraction that represents any one or more separate physical buses, point to point connections, or both connected by appropriate bridges, adapters, or controllers. The interconnect 915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The memory 910 and storage devices 920 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 910 can be implemented as software and/or firmware to program the processor(s) 905 to carry out actions described above. In some embodiments, such software or firmware may be initially provided to the computing system 900 by downloading it from a remote system through the computing system 900 (e.g., via network adapter 930).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed:

1. An extended reality (XR) device for displaying a digital representation of a physical artwork in an XR environment, comprising:
a display screen;
a processor;
a network transceiver configured to communicate with a distributed network that supports a cryptographic ledger; and
a memory storing instructions, which when executed by the processor, cause the extended reality device to:
identify, by an indication of a distributed network application, image data of the physical artwork available for integration into the XR environment, wherein the indication is based on reference to the cryptographic ledger via communication with the distributed network including a link between at least one cryptographic token and a cryptographic address associated with a user of the XR device;
load the image data; and
render, by the display screen, the image data of the physical artwork into the XR environment.

2. The XR device of claim 1, wherein said load instruction includes communicating over a network to obtain the image data from a database.

3. The XR device of claim 1, wherein said load instruction includes inspecting the cryptographic ledger to obtain the image data.

4. The XR device of claim 1, wherein the XR environment is a representation of a historic site.

5. The XR device of claim 1, wherein the image data is associated with contextual metadata, and wherein the XR device is further caused to augment the XR environment with augmented content based on the contextual metadata.

6. The XR device of claim 5, wherein the augmented content is audio content.

7. The XR device of claim 1, wherein the indication is further based on a temporal component that indicates a time the image data is displayable in the XR environment.

8. The XR device of claim 1, wherein the indication is further based on event component that indicates an XR event in which the image data is displayable in the XR environment.

9. The XR device of claim 1, wherein the XR device is further caused to:
receive a user input; and
publish a social feed including the user input to XR environment.

10. The XR device of claim 1, wherein the XR environment includes an anchor point or slot where the image data is inserted.

11. A method for displaying a digital representation of a physical artwork in an XR environment comprising:
identifying, by an indication of a distributed network application executing on an XR device, image data of the physical artwork available for integration into the XR environment, wherein the indication is based on reference to the cryptographic ledger via communication with the distributed network including a link between at least one cryptographic token and a cryptographic address associated with a user of the XR device;
loading the image data; and
rendering, on a display screen of the XR device, the image data of the physical artwork into the XR environment.

12. The method of claim 11, wherein the image data is associated with contextual metadata, the method further comprising:
augmenting the XR environment with content based on the contextual metadata.

13. The method of claim 12, wherein the contextual metadata indicates a time period associated with the artwork, and wherein the content is audio content associated with the time period.

14. The method of claim 11, wherein said loading the image data is based on a temporal component that indicates a time the image data is displayable in the XR environment.

15. The method of claim 11, wherein said loading the image data is based on event component that indicates an event in which the image data is displayable in the XR environment.

16. The method of claim 11, further comprising:
receiving a user input; and
publishing a feed including the user input to XR environment.

17. The method of claim 11, wherein the XR environment includes an anchor point or slot, and wherein the image data is rendered in a position corresponding to the anchor point or slot.

18. A system comprising:
an image scanning subsystem configured to:
scan a physical artwork, and
generate image data of the physical artwork;
a distributed network supporting a cryptographic ledger; and
an extended reality device including:
a display screen;
a processor;
a network transceiver configured to communicate with the distributed network; and
a memory storing instructions, which when executed by the processor, cause the extended reality device to:
identify, by an indication of a distributed network application, that the image data of the physical artwork is available for integration into the XR environment, wherein the indication is based on reference to the cryptographic ledger via communication with the distributed network including a link between at least one cryptographic token and a cryptographic address associated with a user of the XR device;
load the image data; and
render, by the display screen, the image data of the physical artwork into the XR environment.

19. The system of claim 18, wherein the image data is associated with contextual metadata.

20. The system of claim 18, further comprising:
at least one third-party server,
wherein the extended reality device is further caused to:
retrieve, over a network, social media content from the third-party server based on the reference to the cryptographic ledger; and
augment the XR environment with the social media content.
